(19) United States
(12) Patent Application Publication
(10) Pub. No.: US 2018/0281938 A1
(43) Pub. Date: Oct. 4, 2018

(54) LOW NOISE ROTOR BLADE DESIGN

(71) Applicant: Sikorsky Aircraft Corporation, Stratford, CT (US)

(72) Inventors: Mark W. Scott, Bethany, CT (US); Daniel W. Shannon, Glastonbury, CT (US); Daniel Caleb Sargent, Stratford, CT (US); Fredric H. Schmitz, Palo Alto, CA (US)

(21) Appl. No.: 15/544,685

(22) PCT Filed: Nov. 19, 2015
(86) PCT No.: PCT/US2015/061465

§ 371 Date: Jul. 19, 2017

Related U.S. Application Data
(60) Provisional application No. 62/106,331, filed on Jan. 22, 2015.

(51) Int. Cl. B64C 27/467; B64C 27/46

(52) U.S. Cl. CPC B64C 27/467; B64C 27/463

(57) ABSTRACT

A rotor blade includes an elongated body having a leading edge, a trailing edge, a proximal end, and a distal end; a fluid inlet; a fluid outlet arranged near the distal end of the elongated body; and a fluid duct contained within the elongated body, the fluid duct being substantially open between the fluid inlet and the fluid outlet, the fluid duct having a shape to reduce fluid velocities C generated by the interaction of fluid exiting the fluid duct and external fluid at the distal end.

### STATEMENT REGARDING FEDERALLY SPONSORED RESEARCH OR DEVELOPMENT

This invention was made with Government support under Contract No. W911W6-11-2-0001 with the United States Army. The Government therefore has certain rights in this invention.

### BACKGROUND

Recent passive and active rotor blade designs are a compromise between performance, weight, and noise. Of particular issue to the present disclosure is the noise radiated by the rotor near the tip path plane (TPP) which tends to travel large distances. The reduction of near tip path plane rotor noise is a concern for both civil and military applications. The present disclosure relates generally to rotors and, more particularly, to the reduction of noise caused by the movement of aircraft rotor blades.

### SUMMARY OF THE INVENTION

An exemplary embodiment is a rotor blade including an elongated body having a leading edge, a trailing edge, a proximal end, and a distal end; a fluid inlet; a fluid outlet arranged near the distal end of the elongated body; and a fluid duct contained within the elongated body, the fluid duct being substantially open between the fluid inlet and the fluid outlet, the fluid duct having a shape to reduce fluid velocities generated by the interaction of fluid exiting the fluid duct and external fluid at the distal end.

In addition to one or more of the features described above or below, or as an alternative, further embodiments could include wherein the fluid duct has a shape that varies as a function of distance from the fluid outlet.

In addition to one or more of the features described above or below, or as an alternative, further embodiments could include a flow modulator located in the fluid duct which modulates the rate of fluid flow in the fluid duct each revolution.

In addition to one or more of the features described above or below, or as an alternative, further embodiments could include wherein the flow modulator includes at least one of a valve and a pump.

In addition to one or more of the features described above or below, or as an alternative, further embodiments could include wherein the fluid duct contains a bend located at or approaching the fluid outlet that turns the fluid duct.

In addition to one or more of the features described above or below, or as an alternative, further embodiments could include wherein the distal end is at least partially scarfed in the direction of the trailing edge so to as to be substantially non-parallel with the external fluid flow at the distal end.

In addition to one or more of the features described above or below, or as an alternative, further embodiments could include wherein the fluid outlet comprises a rounded portion on a trailing side of the fluid duct such that the fluid duct chord gradually lengthens as a function of distance to the fluid outlet.

Another exemplary embodiment is a rotor system including a central hub which rotates about an axis; and rotor blades connected to the central hub to rotate about the axis, each rotor blade including: an elongated body having a leading edge, a trailing edge, a proximal end adjacent the hub, and a distal end; a fluid inlet; a fluid outlet arranged near the distal end of the elongated body; and a fluid duct contained within the elongated body substantially open between the fluid inlet and the fluid outlet, the fluid duct having a shape to reduce fluid velocities generated by the interaction of fluid exiting the fluid duct and external fluid at the distal end.

In addition to one or more of the features described above or below, or as an alternative, further embodiments could include wherein the fluid duct has a shape that varies as a function of distance from the fluid outlet.

In addition to one or more of the features described above or below, or as an alternative, further embodiments could include a flow modulator in communication with the fluid duct which modulates the rate of flow of the fluid in the fluid duct.

In addition to one or more of the features described above or below, or as an alternative, further embodiments could include wherein the flow modulator comprises at least one of a valve and a pump.

In addition to one or more of the features described above or below, or as an alternative, further embodiments could include wherein the fluid duct contains a bend located at or approaching the fluid outlet that turns the fluid duct towards the trailing edge.

In addition to one or more of the features described above or below, or as an alternative, further embodiments could include wherein the distal end is at least partially scarfed in the direction of the trailing edge so to as to be substantially non-parallel with the external fluid flow at the distal end.

In addition to one or more of the features described above or below, or as an alternative, further embodiments could include wherein the fluid outlet comprises a rounded portion on a trailing side of the fluid duct such that the fluid duct chord gradually lengthens as a function of distance to the fluid outlet.

In addition to one or more of the features described above or below, or as an alternative, further embodiments could include wherein the rotor blades are part of at least one of a main rotor, a tail rotor and a propeller.

In addition to one or more of the features described above or below, or as an alternative, further embodiments could include an aircraft including the rotor system.

In addition to one or more of the features described above or below, or as an alternative, further embodiments could include the aircraft being a rotary wing aircraft.

### BRIEF DESCRIPTION OF THE DRAWINGS

The following descriptions should not be considered limiting in any way. With reference to the accompanying drawings, like elements are numbered alike:

FIG. 1 is a side view of a rotary aircraft employing a rotor system according to one embodiment;

FIG. 2A is a partially sectioned plan view of a rotor blade according to another embodiment;

FIG. 2B is a partially sectioned plan view of a rotor blade according to another embodiment; and

FIGS. 3A-3C are sectioned plan views of a distal end of a rotor blade according to further embodiments.

### DETAILED DESCRIPTION

Those skilled in the art of pneumodynamics and in particular turbo machinery know that a radial duct rotating about an axis naturally pumps fluid from the inner radius to the outer radius due to the centrifugal force acting on the fluid mass. The faster the rotation and the farther the duct exit is from the center of rotation the stronger the pumping. A hollow rotor blade fits this description. A rotor spins at a high rate and has a long duct creating a large pumping force.

The rapid ejection of fluid into a free medium of similar density in the rotating frame of reference creates a positively skewed acoustic pressure wave in the static far-field frame of reference. Those skilled in the art of rotor blade acoustics know the thickness and aerodynamic loading of a rotating blade creates a negatively skewed acoustic pressure wave at a far-field observer location near the rotor tip path plane. Embodiments described herein pump air through a blade. The pumped air can remain at constant velocity or be modulated. The exit flow at the blade tip produces a positive acoustic pressure wave that cancels the negative acoustic pressure wave generated by the blade. The net result is rotor blade noise reduction for the near tip path plane far-field observer. This effect has been repeatedly proven by test.

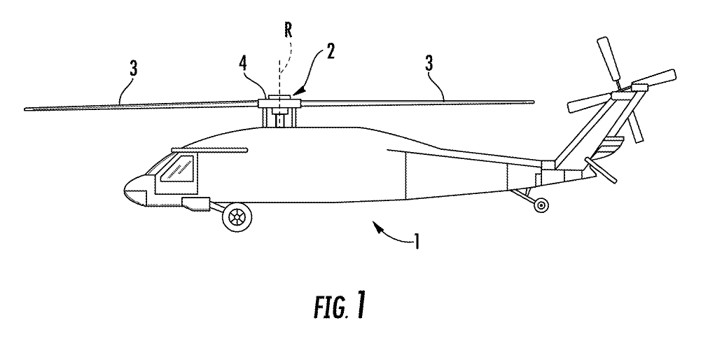

FIG. 1 illustrates one embodiment of the present disclosure, in which a rotary wing aircraft 1 employs a rotor system 2. The rotor system 2 includes a plurality of blades 3 arranged to rotate about a central hub 4, and rotational axis R. The rotary wing aircraft 1 may be a helicopter, as shown, or may be any other aircraft that employs a rotary propulsor such as an airplane or high speed VTOL aircraft. The rotor system 2 is depicted in use with a rotary aircraft, but may also be employed in a number of useful applications, wind turbines, maritime propellers and other devices that typically use rotor systems. Further, while shown in the context of a single rotor aircraft, it is understood that aspects can be used in coaxial contra-rotating aircraft, fixed wing aircraft, and other types of aircraft. Further, although embodiments are described with reference to main rotor blades, embodiments are also applicable to tail rotor blades, propeller blades, etc.

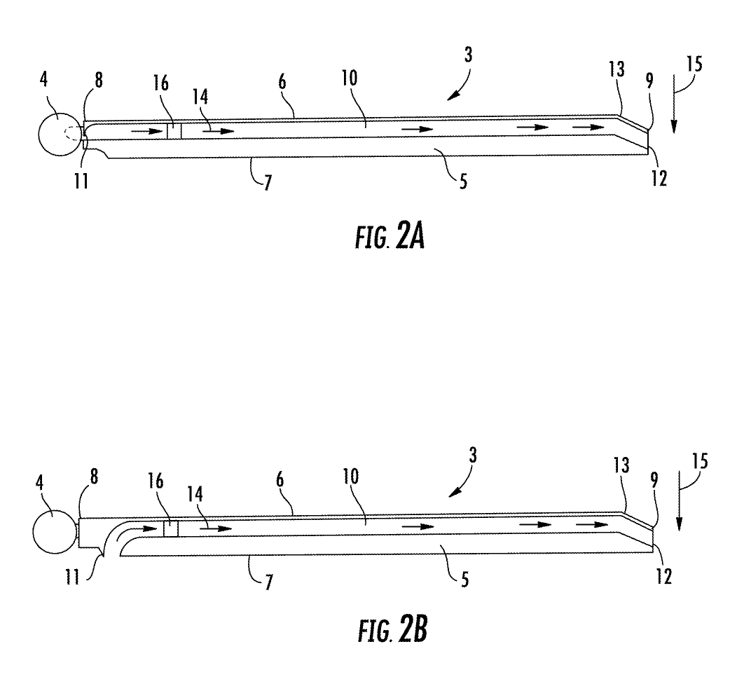

FIG. 2A illustrates a blade 3 for use in the rotor system 2 of the present disclosure and as described above. The blade is comprised of an elongated body 5 having a leading edge 6 and a trailing edge 7. A proximal end 8 of the elongated body 5 is configured to be attached to the central hub 4. A distal end 9 of the elongated body 5, comprising the tip of the rotor blade 3, is located furthest from the central hub 4. The blade 3 contains an airflow duct 10 that runs internal to the elongated body 5. The airflow duct 10 connects to an airflow inlet 11, located at or near the proximal end 8, and an airflow outlet 12 located at or near the distal end 9. As shown in FIG. 2A, the airflow inlet 11 may be located at the connection to the central hub 4, which may further comprise a secondary inlet for receiving airflow. FIG. 2B illustrates another embodiment in which the airflow inlet 11 is located near the proximal end 8 of the elongated body 5, along the trailing edge 7. Though the airflow inlet 11 is shown at the trailing edge 7 in FIG. 2B or at the connection to the central hub 4, it is understood that the inlet 11 can be located anywhere along the blade 3, including the leading edge 6 or the upper or lower surfaces of the airfoil, and that plural inlets could be used in combinations of these configurations.

As used herein, the phrase “near the proximal end” shall be construed to mean at least closer to the proximal end 8 than the distal end 9. Referring to FIGS. 2A and 2B, the airflow duct 10 includes a bend 13 in the direction of the trailing edge 7 as the airflow, (shown by arrows 14), approaches the distal end 9 of the blade 3. The bend 13 is not required in all aspects of the invention, but may be present to meet rotor performance or other requirements. The tip of blade 3 could also have anhedral or dihedral features at the distal end 9, as known in the art. Further, as the airflow duct 10 approaches the distal end 9, the airflow duct 10 is substantially open, meaning that it contains minimal choke points, or other flow restrictions.

The airflow in the duct 10 is created by the rotation of the blade 3 which pumps air from the inner radius to the outer radius due to the centrifugal force acting on the air. The faster the rotation and the farther the duct exit is from the center of rotation, the stronger the pumping. However, it is understood that additional airflow could be provided using a mechanical device, such as a pump, in addition to centrifugal force.

As shown in FIGS. 2A and 2B, the internal duct flow 14 can operate in a steady flow or unsteady flow as controlled by a flow modulator 16. Though shown near the proximal end 8, the flow modulator 16 can be located anywhere in the duct 10. Additionally, in other aspects of the invention, the flow modulator 16 can be disposed off the rotor 3, such as on the vehicle 1 or hub assembly 4 and feed the modulated air into the rotor blade duct 10. The flow modulator 16 can be an electric, mechanical, or pneumatic valve and include a controller which modulates the flow of the air. The modulation achieves a specific flow rate schedule versus time to result in the desired noise reduction for the near tip path plane far-field observer. Additionally or alternatively, an air pumping device such as a mechanical pump can be added to the fuselage, hub, or blades to augment the natural centrifugal pumping created by the rotor. The air pumping device can also act as a flow modulator.

As shown in FIGS. 2A and 2B, the internal duct airflow 14 interacts with the external flow 15, which is a combination of the aircraft forward flight and the rotational velocity of the blade, at the distal end 9. This interaction causes high velocity flow and turbulence which is counterproductive to the improvement of aerodynamics, vibration, noise, and/or heat transfer characteristics generated by the duct flow. Embodiments are meant to reduce or eliminate the peak, high velocity and turbulent region near the tip caused by the interaction of the internal duct flow 14 with the external flow 15.

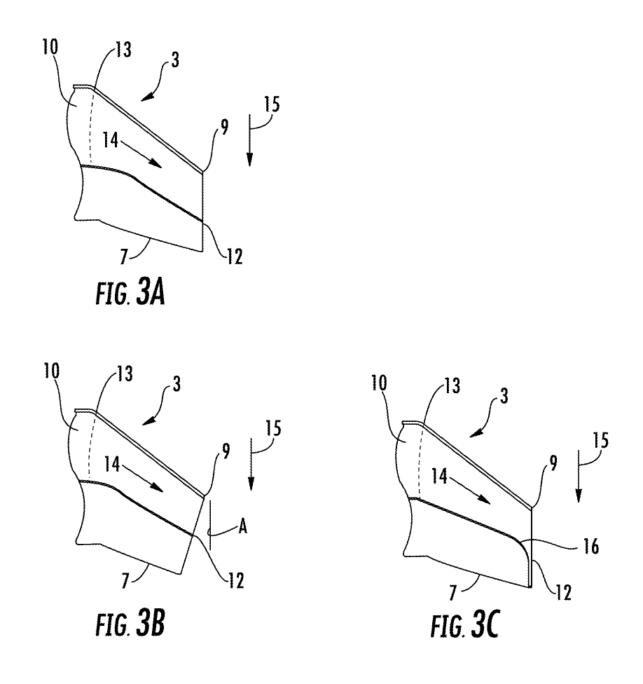

FIGS. 3A-3C illustrate the distal end 9 of the blade 3 and the airflow duct 10 contained therein according to various embodiments. FIG. 3A shows an embodiment in which the bend 13 turns the airflow duct 10 towards the trailing edge 7, as discussed above. The bend 13 is not a necessary feature for the disclosures, herein, but is included as a common feature of rotor blades 3 including the shown examples.

FIG. 3B illustrates another embodiment of the rotor blade 3 in which the distal end 9 is “scarfed” towards the trailing edge 7, or cut at an angle A relative to the external flow 15, thereby partially shielding the exiting airflow 14 from the external airflow and/or blade tip vortices. The distal end 9 may be cut at an angle A which shields the internal flow from the external flow allowing for reduced peak velocities and turbulence when the internal flow 14 and external flow 15 mix. As shown, the general range for angle A is about 30 degrees, although the invention is not limited thereto. In alternative embodiments, the distal end 9 may be partially scarfed; i.e., cut at an angle over a portion of the distal end 9 in the chordwise direction, with the remainder of the distal end 9 configured at a different angle, such as perpendicular to the direction of the rotating blade 3 or substantially parallel to the external flow 15. The chordwise direction is the direction following the chord, which is a straight line joining the leading and trailing edges of the airfoil.

FIG. 3C illustrates another embodiment of the rotor blade 3 which includes a rounding portion 16 on a trailing side of the airflow duct 10 intended to aid the mixing of the internal flow 14 with the external flow 15. Specifically, the rounding portion 16 gradually lengthens the chord of the duct 10 as it approaches the outlet 12. This allows for the internal flow 14 to partially turn more parallel with the external flow 15 before exiting the duct thereby reducing the negative impact of the flow interaction. While described in terms of a rounding portion 16, it is understood that other shapes can accomplish the gradual expansion other than round or elliptical shapes, including linear shapes in aspects of the invention.

Aspects of the invention described herein include a highly effective means to actively reduce rotor near tip path plane noise without incurring high weight increase, design complexity or reduced rotor performance. However, it is understood that aspects of the invention may have other advantages not specifically mentioned depending on the specific implementation.

While the invention has been described with reference to an exemplary embodiment or embodiments, it will be understood by those skilled in the art that various changes may be made and equivalents may be substituted for elements thereof without departing from the scope of the invention. By way of example, aspects of the invention can also be used on other types of devices with rotors including fixed wing aircraft propellers and wind turbines. Further, while described in terms of air, it is understood that aspects can be used with any fluid, including other gases or liquids, through which a propeller or rotor can be used.

In addition, many modifications may be made to adapt a particular situation or material to the teachings of the invention without departing from the essential scope thereof. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc., do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A rotor blade, comprising:
an elongated body having a leading edge, a trailing edge, a proximal end, and a distal end;
a fluid inlet;
a fluid outlet arranged near the distal end of the elongated body; and
a fluid duct contained within the elongated body, the fluid duct being substantially open between the fluid inlet and the fluid outlet, the fluid duct having a shape to reduce fluid velocities generated by the interaction of fluid exiting the fluid duct and external fluid at the distal end.

2. The rotor blade of claim 1, wherein the fluid duct has a shape that varies as a function of distance from the fluid outlet.

3. The rotor blade according to claim 1, further comprising a flow modulator located in the fluid duct which modulates a rate of fluid flow in the fluid duct each revolution.

4. The rotor blade of claim 3, wherein the flow modulator comprises at least one of a valve and a pump.

5. The rotor blade according to claim 1, wherein the fluid duct contains a bend located at or approaching the fluid outlet that turns the fluid duct.

6. The rotor blade according to claim 1, wherein the distal end is at least partially scarfed in the direction of the trailing edge so to as to be substantially non-parallel with the external fluid flow at the distal end.

7. The rotor blade according to claim 1, wherein the fluid outlet comprises a rounded portion on a trailing side of the fluid duct such that the fluid duct chord gradually lengthens as a function of distance to the fluid outlet.

8. A rotor system, comprising:
a central hub which rotates about an axis; and
rotor blades connected to the central hub to rotate about the axis, each rotor blade comprising:
an elongated body having a leading edge, a trailing edge, a proximal end adjacent the hub, and a distal end;
a fluid inlet;
a fluid outlet arranged near the distal end of the elongated body; and
a fluid duct contained within the elongated body substantially open between the fluid inlet and the fluid outlet, the fluid duct having a shape to reduce fluid velocities generated by the interaction of fluid exiting the fluid duct and external fluid at the distal end.

9. The rotor system of claim 8, wherein the fluid duct has a shape that varies as a function of distance from the fluid outlet.

10. The rotor system according to claim 8, further comprising a flow modulator in communication with the fluid duct which modulates a rate of flow of the fluid in the fluid duct.

11. The rotor system of claim 10, wherein the flow modulator comprises at least one of a valve and a pump.

12. The rotor system according to claim 8, wherein the fluid duct contains a bend located at or approaching the fluid outlet that turns the fluid duct towards the trailing edge.

13. The rotor system according to claim 8, wherein the rotor blades are part of at least one of a main rotor, a tail rotor and a propeller.

14. An aircraft comprising the rotor system according to claim 8.

15. The aircraft of claim 14, wherein the aircraft comprises a rotary wing aircraft.
